(19) United States
(12) Patent Application Publication
(10) Pub. No.: US 2006/0114504 A1
(43) Pub. Date: Jun. 1, 2006

(54) Data management system and image forming apparatus

(75) Inventors: Satoshi Oguri, Osaka-shi (JP); Toshinobu Yoshida, Osaka-shi (JP); Manami Kawamoto, Osaka-shi (JP); Kenichi Mizusu, Osaka-shi (JP)

Correspondence Address: CASELLA & HESPOS, 274 MADISON AVENUE, NEW YORK, NY, 10016, US

(73) Assignee: Kyocera Mita Corporation, Osaka-shi (JP)

(21) Appl. No.: 11/290,946

(22) Filed: Nov. 30, 2005

(30) Foreign Application Priority Data
Nov. 30, 2004 (JP) 2004-345966

(51) Int. Cl. G06F 3/12

(52) U.S. Cl. 358/1.15

(57) ABSTRACT

A complex machine is provided with a HDD in which a data is to be stored, and a control unit for instructing the storage of a data in the HDD. If the data storage is instructed, the control unit confirms the free capacity of the HDD and those of HDDs of other complex machines connected on a network to compare the free capacities of the respective HDDs, and transmits the data to the other complex machine including the HDD judged to have a largest free capacity. Accordingly, there can be provided a data management system capable of equalizing data amounts saved in a plurality of image forming apparatuses on a network, and an image forming apparatus enabling such a data management system.

### BACKGROUND OF THE INVENTION

1. Field of the Invention

The present invention relates to a data management system in which a plurality of image forming apparatuses are connected via a network and to an image forming apparatus connected with a plurality of image forming apparatuses via a network.

2. Description of the Related Art

An image output system in which a plurality of image forming apparatuses are connected on a network has been conventionally known (see, for example, Japanese Unexamined Patent Publication No. 2003-271348). There is a method for ripping data using a part of a memory area of a HDD (hard disk drive) as a work area upon processing a print job of a large data capacity such as color printing in such an image forming apparatus.

For example, thought is being put into an image forming apparatus for administering document images read by a scanner by means of a database. In the case of such an image forming apparatus, data such as document image are stored in a HDD. If data are always stored in a definite HDD of one of a plurality of image forming apparatuses on a network, there is a possibility that the aforementioned print job having a large data amount cannot be processed due to the saturated capacity of the HDD of this image forming apparatus.

### SUMMARY OF THE INVENTION

In view of the problem residing in the prior art, an object of the present invention is to provide a data management system capable of equalizing data amounts to be stored in a plurality of image forming apparatuses connected on a network, and an image forming apparatus enabling such a data management system.

The present invention is directed to a data management system in which a plurality of image forming apparatuses are connected via a network, characterized in that one of a plurality of image forming apparatuses comprises data storage means for storing a data, instructing means for instructing the storage of the data, capacity comparing means for confirming the free capacity of the data storage means of the one image forming apparatus with that of data storage means of each other image forming apparatus connected on the network to compare the free capacities of the respective data storage means if the data storage is instructed by the instructing means, and data transmitting means for transmitting the data to the other image forming apparatus comprising the data storage means judged to have a largest free capacity by the capacity comparing means; and each other image forming apparatus comprises the data storage means for storing a data, data receiving means for receiving the data transmitted by the data transmitting means, and data storage controlling means for storing the data received by the data receiving means in the data storage means.

According to this construction, the data storage is instructed by the instructing means of the one image forming apparatus out of the plurality of image forming apparatuses and, upon such an instruction, the capacity comparing means confirms the free capacity of the data storage means of the one image forming apparatus and that of the data storage means of each other image forming apparatus to compare the free capacities of the respective data storage means. Then, the data transmitting means transmits the data to the other image forming apparatus comprising the data storage means judged to have a largest free capacity by the capacity comparing means. The data receiving means of the other image forming apparatus receives the data transmitted by the data transmitting means and the data storage controlling means stores the data received by the data receiving means in the data storage means.

Accordingly, data are stored in a decentralized manner depending on the free capacities of the respective data storage means of the plurality of image forming apparatuses connected on the network. Hence, the data amounts stored in the respective image forming apparatuses connected on the network can be equalized. This can prevent the saturation of the capacities of the data storage means. Therefore, even if a print job of a large capacity is created, this print job can be processed.

The present invention is also directed to an image forming apparatus connected with a plurality of image forming apparatuses via a network, comprising data storage means for storing a data; instructing means for instructing the storage of the data; capacity comparing means for confirming the free capacity of the data storage means of the image forming apparatus with that of data storage means of each other image forming apparatus connected on the network to compare the free capacities of the respective data storage means if the data storage is instructed by the instructing means; data transmitting means for transmitting the data to the other image forming apparatus if the free capacity of the other image forming apparatus is judged to be larger than that of the image forming apparatus by the capacity comparing means; and data storage controlling means for storing the data in the data storage means if the free capacity of the image forming apparatus is judged to be larger than that of each other image forming apparatus by the capacity comparing means.

According to this construction, if the data storage is instructed by the instructing means, the capacity comparing means compares the free capacity of the data storage means of the image forming apparatus with that of the data storage means of each other image forming apparatus connected on the network to compare the free capacities of the respective data storage means. If the free capacity of the other image forming apparatus is judged to be larger than that of the image forming apparatus by the capacity comparing means, the data is transmitted to the other image forming apparatus by the data transmitting means. On the other hand, if the free capacity of the image forming apparatus is judged to be larger than that of each other image forming apparatus by the capacity comparing means, the data is stored in the data storage means by the data storage controlling means.

Since data can be stored in a decentralized manner depending on the free capacities of the respective data storage means of a plurality of image forming apparatuses connected on the network, the data amounts stored in a plurality of image forming apparatuses connected on the network can be equalized. This can prevent the saturation of the capacities of the data storage means. Therefore, even if a print job of a large capacity is created, this print job can be processed.

These and other objects, features, aspects and advantages of the present invention will become more apparent upon a reading of the following detailed description and accompanying drawings.

### BRIEF DESCRIPTION OF THE DRAWINGS

FIG. 1 is a block diagram showing a construction of a data management system according to one embodiment of the invention.

FIG. 2 is a block diagram schematically showing an internal construction of a complex machine as one example of an image forming apparatus according to one embodiment of the invention.

FIG. 3 is a flow chart showing the operation of the complex machine shown in FIG. 2.

### DETAILED DESCRIPTION OF THE PREFERRED EMBODIMENTS

Hereinafter, one embodiment of the present invention is described with reference to the accompanying drawings. It should be noted that the following embodiment is only one embodiment of the present invention and does not restrict the technical scope of the present invention.

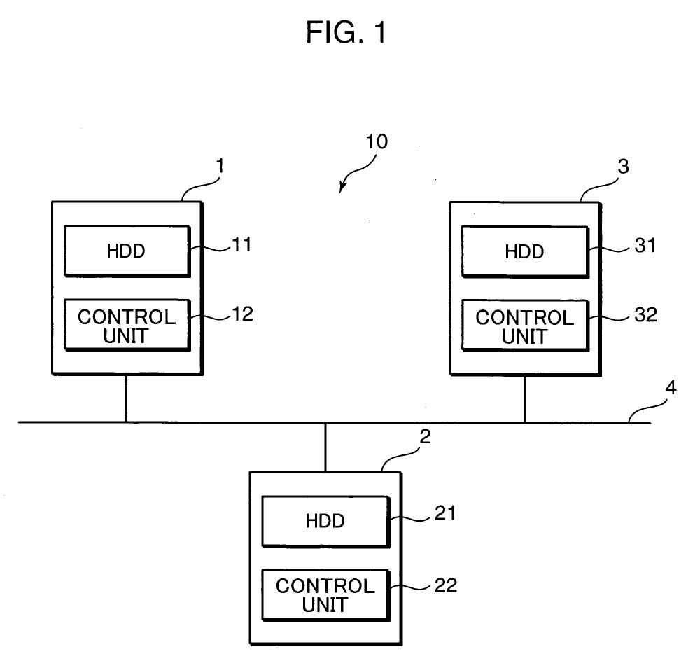

FIG. 1 is a block diagram showing a construction of a data management system according to one embodiment of the present invention. A data management system 10 shown in FIG. 1 includes a first complex machine 1, a second complex machine 2 and a third complex machine 3. The first to third complex machines 1 to 3 are communicably connected with each other via a LAN (local area network) 4. Each complex machine 1, 2, 3 as an example of an image forming apparatus is a copier having composite functions including a scanner function, a facsimile function, a printer function and a copier function. Various functions can be realized by combining these functions in the complex machines 1, 2, 3. Although three complex machines 1, 2, 3 are connected via the LAN 4 in the data management system 10 in this embodiment, the present invention is not particularly limited thereto and four or more or two complex machines may be connected.

Each complex machine 1, 2, 3 is comprised of a HDD (hard disk drive) 11, 21, 31 and a control unit 12, 22, 32. The HDD 11, 21, 31 as one example of data storage means is for storing data, and the control unit 12, 22, 32 is for monitoring and governing the HDD 11, 21, 31. The control units 12, 22, 32 grasp storable remaining capacities of the corresponding HDDs 11, 21, 31, and store data in a decentralized manner so that the resulting storage capacities of the HDDs 11, 21, 31 become equal. The control units 12, 22, 32 conduct transmission and reception in such a manner as not to interfere with each other. For example, in the case where the first complex machine 1 stores a data in the HDD 21 of the second complex machine 2, the control unit 22 of the second complex machine 2 comes under the control of the control units 12 of the first complex machine 1 and is freed upon the completion of the data storage.

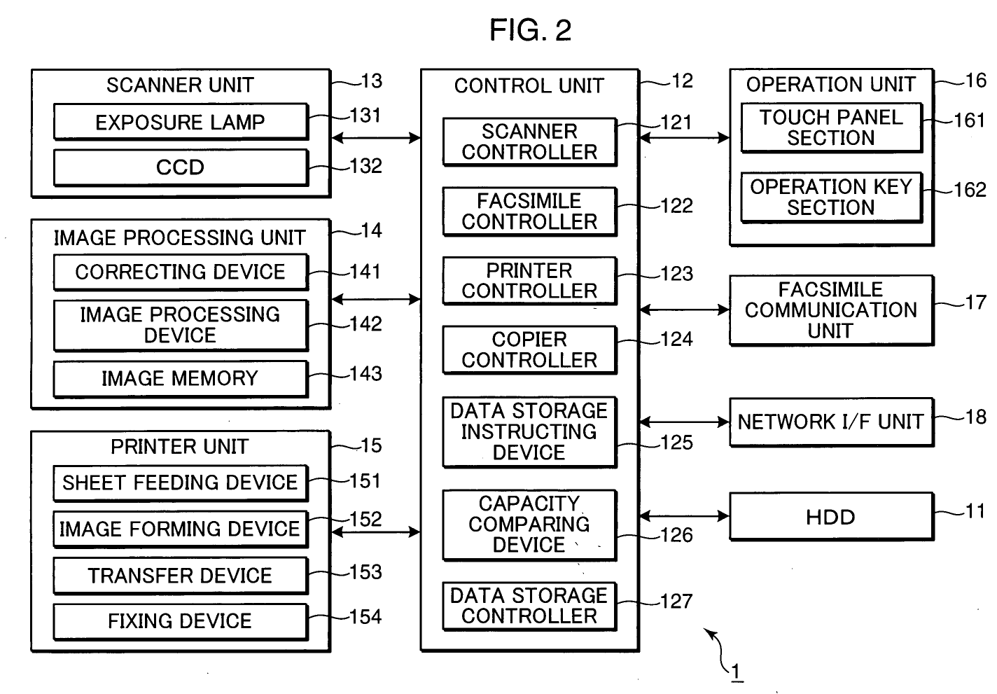

Next, the construction of each complex machine is described in more detail. FIG. 2 is a block diagram schematically showing an internal construction of the complex machine as one example of the image forming apparatus according to one embodiment of the present invention. FIG. 2 shows the construction of the first complex machine 1, but the other complex machines 2, 3 have similar constructions.

The first complex machine 1 includes the HDD 11, the control unit 12, a scanner unit 13, an image processing unit 14, a printer unit 15, an operation unit 16, a facsimile communication unit 17 and a network I/F (interface) unit 18.

In this embodiment, a scanner function is realized by the HDD 11, the control unit 12, the scanner unit 13, the image processing unit 14 and the operation unit 16. A facsimile function is realized by the HDD 11, the control unit 12, the scanner unit 13, the image processing unit 14, the printer unit 15, the operation unit 16 and the facsimile communication unit 17. A printer function is realized by the HDD 11, the control unit 12, the image processing unit 14, the printer unit 15 and the network I/F unit 18. A copier function is realized by the HDD 11, the control unit 12, the scanner unit 13, the image processing unit 14, the printer unit 15 and the operation unit 16.

The operation unit 16 is comprised of a touch panel section 161 including a touch panel and the like, and an operation key section 162 including a start key and a numeric keypad. The operation unit 16 is used by a user to carry out operations relating to the scanner function, the facsimile function, the printer function, the copier function and other functions, and gives operation commands and the like from the user to the control unit 12. The touch panel section 161 is constructed by a touch panel unit which is a combination of a touch panel and a LCD (liquid crystal display), and displays various operation screens. For example, the touch panel section 161 displays information on the document size, the copy size, and the number of sets to be printed upon carrying out the copier function and also displays operations buttons and the like used by the user to input various operation commands by touching. The operation key section 162 is used by the user to input a copying command the like.

The control unit 12 functions as a scanner controller 121, a facsimile controller 122, a printer controller 123, a copier controller 124, a data storage instructing device 125, a capacity comparing device 126, and a data storage controller 127. The control unit 12 includes a microcomputer and a hardware circuit for exclusive use and controls the operation of the entire apparatus. The scanner controller 121 controls the operations of the respective components used to realize the scanner function. The facsimile controller 122 controls the operations of the respective components used to realize the facsimile function. The printer controller 123 controls the operations of the respective components used to realize the printer function. The copier controller 124 controls the operations of the respective components used to realize the copier function.

The data storage instructing device 125 instructs the storage of the data in the HDD 11. The capacity comparing device 126 confirms the free capacities of the HDDs of the other complex machines and compares the free capacities of the respective HDDs if the data storage is instructed by the data storage instructing device 125. The data storage controller 127 stores the data in the HDD if the capacity comparing device 126 judged the free capacity of the complex machine 1 to be larger than those of the other complex machines 2, 3 or if the data was received by the network I/F unit 18. It should be noted that the capacity comparing device 126 corresponds to one example of confirming means.

The scanner unit 13 includes an exposure lamp 13 and CCDs (charge-coupled devices) 132 constructing a scanner for successively reading documents being conveyed. The scanner unit 13 illuminates the document by means of the exposure lamp 131 and receives the reflected light by means of the CCDs 132, thereby reading an image of the document, and outputs an image data corresponding to the read image to the image processing unit 14.

The image processing unit 14 includes a correcting device 141, an image processing device 142, and an image memory 143. The image processing unit 14 processes the read image data by means of the correcting device 141 and the image processing device 142 if necessary, stores the processed image data in the image memory 143 or outputs it to the printer unit 15, the facsimile communication unit 17 or the network I/F unit 18. The correcting device 141 applies a specified correction such as a level correction or a Y-correction to the read image data. The image processing device 142 applies various processings to the image data such compression or decompression and enlargement or reduction.

The printer unit 15 is comprised of a sheet feeding device 151, an image forming device 152, a transfer device 153, and a fixing device 154. The sheet feeding device 151 includes feed rollers and is adapted to dispense the sheet from the sheet cassette and feed it to the respective devices. The image forming device 152 includes a photosensitive drum to be uniformly charged; an exposure device for converting a modulated signal generated based on the image data of the document into a laser beam and outputting the converted laser beam to form an electrostatic latent image on the photosensitive drum; and a developing device for forming a toner image by supplying a specified developer to the photosensitive drum. The transfer device 153 includes a transfer roller and is adapted to transfer the toner image on the photosensitive drum to the sheet conveyed. The fixing device 154 includes fixing rollers and is adapted to fix the transferred toner image onto the sheet by heating. The printer unit 15 prints an image on a sheet using an image data such as a document data read by the scanner unit 13, a print data transmitted from a client PC (personal computer) or the like via the LAN through the network I/F unit 18 or a facsimile data received from an external facsimile apparatus or the like by means of the facsimile communication unit 17. Specifically, the sheet feeding device 151 feeds the sheet to the image forming device 152, which in turn forms the toner image corresponding to the above image data. The transfer device 153 transfers the toner image onto the sheet, and the fixing device 154 fixes the toner image onto the sheet to form an image.

The facsimile communication unit 17 includes a coding/decoding device (not shown), a modem device (not shown) and a NCU (network control unit) (not shown). The facsimile communication unit 17 transmits an image data of a document read by the scanner unit 13 to a facsimile apparatus or the like via a telephone circuit and receives an image data (facsimile data) transmitted from a facsimile apparatus or the like. The coding/decoding device compresses and codes an image data to be transmitted while decompressing and decoding a received image data. The modem device modulates a compressed/coded image data into an audio signal and demodulates a received signal (audio signal) into an image data. The NCU controls the connection with the facsimile apparatus or the like as a transmission/reception end via the telephone circuit. It should be noted that the facsimile communication unit 17 corresponds to one example of facsimile data receiving means.

The network I/F unit 18 controls the transmission and reception of various data to and from client PCs and the like connected via the LAN 4 using a network interface (e.g. 10/100Base-Tx) and, for example, receives a print data (image data) transmitted from a client PC or the like. The network I/F unit 18 also controls the transmission and reception of data to and from the other complex machines connected via the LAN 4. Specifically, the network I/F unit 18 transmits the data to the complex machine provided with the HDD judged to have a largest free capacity by the capacity comparing device 126, and receives data transmitted from the network I/F units 18 provided in other image forming apparatuses. It should be noted that the network I/F unit 18 corresponds to examples of image data receiving means, registration start information transmitting means, registration start information receiving means, confirm instruction transmitting means, confirm instruction receiving means, free capacity transmitting means, free capacity receiving means, registration permitting information transmitting means and registration permitting information receiving means, and the client PC corresponds to one example of an external apparatus.

The HDD 11 is for storing various data such as image data read by the scanner unit 13 and output formats set in the read image data. Image data stored in the HDD 11 are used not only in the first complex machine 1, but also confirmed by the client PCs and the like via the network I/F unit 18 or transferred to specified folders of the client PCs and the like. Fax numbers of facsimile apparatuses for transmitting and receiving data via the facsimile communication unit 17 are also stored in the HDD 11. The user registers these fax numbers using the operation unit 16.

Data compiled into a database are also stored in the HDD 11. Image data read by the scanner unit 13, print data received from the client PCs via the network I/F unit 18, image data received from the facsimile apparatuses via the facsimile communication unit 17 and other data are registered in the database. Information for specifying the complex machine having the image data read by the scanner unit 13 or the like stored in the HDD thereof is also stored in the HDD 11.

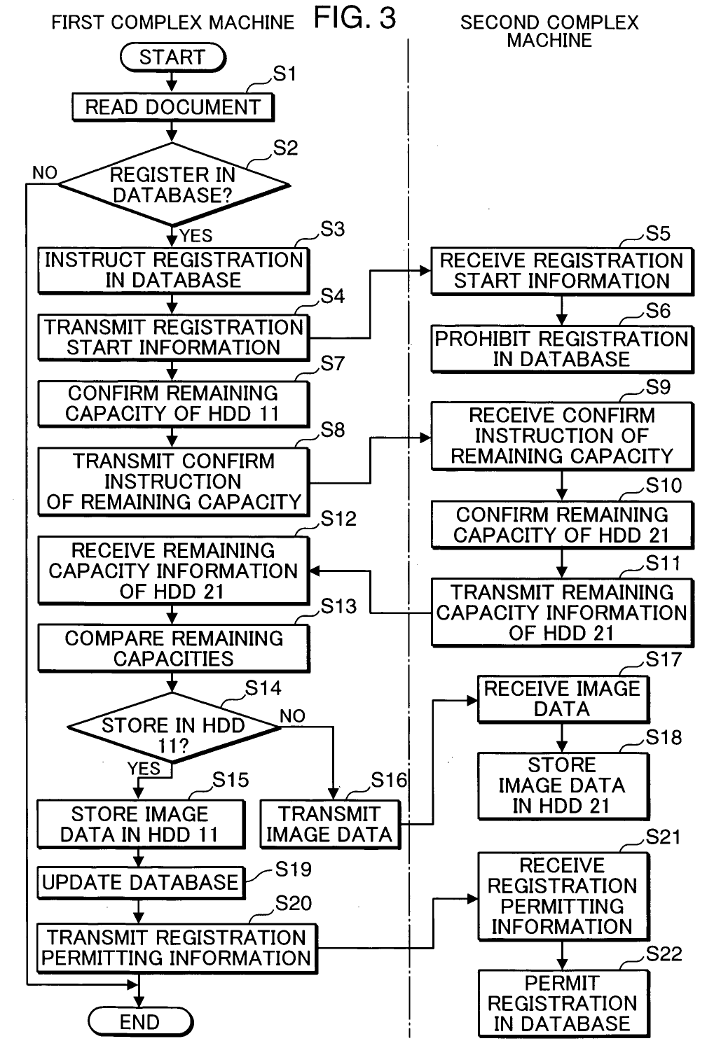

Next, the operation of the complex machine shown in FIG. 2 is described. FIG. 3 is a flow chart showing the operation of the complex machine shown in FIG. 2. In FIG. 3 is described a case where a document image read by the scanner unit 13 is registered in the database. Although processings carried out between the first and second complex machines 1, 2 are described in FIG. 3, similar processings are also carried out between the first and third complex machines 1, 3.

First, in Step S1, the operation unit 16 receives an instruction to read a document, whereupon the scanner unit 13 reads the document and outputs a read document image data to the HDD 11.

Subsequently, in Step S2, the data storage instructing device 125 judges whether or not the document image data read by the scanner unit 13 is to be registered in the database. The registration in the database is judged as follows. A screen used to receive an entry as to whether or not the read image data is to be registered in the database is displayed on the touch panel section 161 of the operation unit 16, and it is judged to register the image data in the database in the case of receiving the entry of the registration in the database while being judged not to register the image data in the database in the case of receiving no such entry. Here, this routine proceeds to Step S3 if it is judged to register the image data in the database (YES in Step S2) while being ended if it is judged not to register the image data in the database (NO in Step S2). Although whether or not the image is to be registered in the database is judged by displaying the screen used to receive the entry as to whether or not the read image data is to be registered in the database on the touch panel section 161 of the operation unit 16 in this embodiment, the present invention is not particularly limited thereto. The read image data may be automatically registered in the database. It should be noted that the touch panel section 161 corresponds to one example of registration receiving means.

If the registration in the database is judged, the data storage instructing device 125 instructs the registration in the database in Step S3.

Subsequently, in Step S4, the network I/F unit 18 transmits registration start information to the other complex machines 2, 3 (second complex machine 2 in FIG. 3) to notify the other complex machines 2, 3 of the start of the registration in the database in the first complex machine 1. The network I/F unit 18 also transmits the registration start information to the third complex machine 3.

Subsequently, in Step S5, the network I/F unit 18 of the second complex machine 2 receives the registration start information transmitted from the first complex machine 1. The network I/F unit 18 of the third complex machine 3 also receives the registration start information transmitted from the first complex machine 1.

Subsequently, in Step S6, the data storage instructing device 125 of the second complex machine 2 prohibits the instruction to register in the database. The data storage instructing device 125 of the third complex machine 3 also prohibits the instruction to register in the database. Specifically, the data storage instructing devices 125 of the second and third complex machines 2, 3 do not instruct the registration in the database in the case of receiving the registration start information. In this way, if the data storage instructing device 125 of one of a plurality of complex machines connected on the network instructs the data storage, those 125 of the other complex machines do not instruct the data storage. In such a case, out of a plurality of complex machines, there is always only one complex machine that can instruct the data storage to the other complex machines. This can prevent a plurality of complex machines from simultaneously storing the data.

Subsequently, in Step S7, the capacity comparing device 126 confirms the free capacity of a data storage area of the HDD 11 of the first complex machine 1.

Subsequently, in Step S8, the network I/F unit 18 transmits a confirm instruction to the other complex machine (second complex machine 2 in FIG. 3) connected with the LAN 4 to let it confirm the remaining capacity of the HDD thereof. The capacity comparing device 126 also transmits the confirm instruction to the third complex machine 3 connected with the LAN 4.

Subsequently, in Step S9, the network I/F unit 18 of the second complex machine 2 receives the confirm instruction transmitted from the first complex machine 1. The network I/F unit 18 of the third complex machine 3 also receives the confirm instruction transmitted from the first complex machine 1.

Subsequently, in Step S10, the capacity comparing device 126 of the second complex machine 2 confirms the free capacity of the data storage area of the HDD 21 of the second complex machine 2. Similarly, the capacity comparing device 126 of the third complex machine 3 also confirms the free capacity of the data storage area of the HDD 31 of the third complex machine 3.

Subsequently, in Step S11, the network I/F unit 18 of the second complex machine 2 transmits remaining capacity information representing the free capacity of the data storage area of the HDD 21 confirmed by the capacity comparing device 126 to the first complex machine 1. Similarly, the network I/F unit 18 of the third complex machine 3 also transmits remaining capacity information representing the free capacity of the data storage area of the HDD 31 confirmed by the capacity comparing device 126 to the first complex machine 1.

Subsequently, in Step S12, the network I/F unit 18 of the first complex machine 1 receives the remaining capacity information transmitted from the second complex machine 2. The network I/F unit 18 of the first complex machine 1 also receives the remaining capacity information transmitted from the third complex machine 3.

Subsequently, in Step S13, the capacity comparing device 126 compares the free capacity of the data storage area of the HDD 11 of the first complex machine 1, that of the data storage area of the HDD 21 of the second complex machine 2 and that of the data storage area of the HDD 31 of the third complex machine 3.

Subsequently, in Step S14, the capacity comparing device 126 judges whether or not the image data is to be stored in the HDD 11 of the first complex machine 1. In other words, the image data is stored in the HDD 11 if the capacity comparing device 126 judges the free capacity of the data storage area of the HDD 11 of the first complex machine 1 to be larger than those of the data storage areas of the HDDs 21, 31 of the other complex machines 2, 3.

If it is judged to store the image data in the HDD 11, the data storage controller 127 executes such a control as to store the image data in the HDD 11 and the image data read by the scanner unit 13 is stored in the HDD 11 in Step S15.

On the other hand, if it is judged not to store the image data in the HDD 11, i.e. if the free capacity of the data storage area of either one of the HDDs 21, 31 of the other complex machines 2, 3 is larger than that of the data storage area of the HDD 11 of the first complex machine 1, the network I/F unit 18 transmits the image data to the HDD judged to have a largest free capacity in Step S16. FIG. 3 shows an example in which the free capacity of the HDD 21 of the second complex machine 2 is judged to be largest. In this case, the network I/F unit 18 transmits the read image data to the second complex machine 2 including the HDD 21. If the free capacity of the HDD 31 of the third complex machine 3 is judged to be largest, the network I/F unit 18 transmits the read image data to the third complex machine 3 including the HDD 31.

Subsequently, in Step S17, the network I/F unit 18 of the second complex machine 2 receives the image data transmitted from the first complex machine 1.

Subsequently, in Step S18, the data storage controller 127 of the second complex machine 2 executes such a control as to store the received image data in the HDD 21 and the image data read by the scanner unit 13 is stored in the HDD 21.

Subsequently, in Step S19, the data storage controller 127 of the first complex machine 1 registers the read image data anew in the database to update this database. At this time, the image data read by the scanner unit 13 and the complex machine in which this image data is stored are stored in correspondence in the database. Thus, which complex machine includes the HDD having the image data stored can be specified.

Subsequently, in Step S20, the network I/F unit 18 of the first complex machine 1 transmits registration permitting information to the other complex machines 2, 3 (second complex machine 2 in FIG. 3) to notify the other complex machines 2, 3 of the completion of the registration in the database in the first complex machine 1. The network I/F unit 18 also transmits the registration permitting information to the third complex machine 3.

Subsequently, in Step S21, the network I/F unit 18 of the second complex machine 2 receives the registration permitting information transmitted from the first complex machine 1. The network I/F unit 18 of the third complex machine 3 also receives the registration permitting information transmitted from the first complex machine 1.

Subsequently, in Step S22, the data storage instructing device 125 of the second complex machine 2 permits the instruction to register in the database. The data storage instructing device 125 of the third complex machine 3 also permits the instruction to register in the database. In other words, the data storage instructing devices 125 of the second and third complex machines 2, 3 instruct the registration in the database in the case of receiving the registration permitting information.

After carrying out the processings shown in FIG. 3, various image forming processings are carried out by the facsimile controller 122, the printer controller 123 or the copier controller 124.

Although the image data read in the first complex machine 1 is stored in the complex machine in FIG. 3, similar processings are carried also in the case of storing an image data read in the second complex machine 2 in the other complex machine or in the case of storing an image data read in the third complex machine 3 in the other complex machine.

As described above, the data storage in the HDD is instructed by the data storage instructing device 125. Upon such an instruction, the capacity comparing device 126 confirms the free capacities of the HDDs of all the complex machines connected on the network to compare the free capacities of the respective HDDs. Then, the network I/F unit 18 transmits the data to the complex machine including the HDD judged to have a largest free capacity by the capacity comparing device 126, and the network I/F unit 18 of the other complex machine receives the data transmitted by the former network I/F unit 18 and the data storage controller 127 of this other complex machine stores the data received by the network I/F unit 18 in the HDD.

If the capacity comparing device 126 judges to the free capacity of the other complex machine to be larger than that of the complex machine to which the capacity comparing device 126 belongs, the network I/F unit 18 transmits the data to the other complex machine. If the capacity comparing device 126 judges that the free capacity of the complex machine to which the capacity comparing device 126 belongs is larger than the free capacities of the other complex machines or the data is received by the network I/F unit 18, the data storage controller 127 stores the data in the HDD.

Accordingly, data are stored in a decentralized manner depending on the free capacities of the respective HDDs of a plurality of complex machines connected on the network, wherefore the data amounts stored in the respective complex machines connected on the network can be equalized. Further, since the data amounts stored in the respective complex machines are equalized, the saturation of the capacities of the HDDs can be prevented. Therefore, even if a print job of a large capacity is created, it can be processed.

The data complied into the database are stored in each HDD 11, 21, 31, and the data registration in the database of the HDD is instructed by the data storage instructing device 125. Upon such an instruction, the capacity comparing device 126 confirms the free capacities of the HDDs of all the complex machines connected on the network to compare the free capacities of the HDDs. Then, the network I/F unit 18 transmits the data to the complex machine including the HDD judged to have a largest free capacity by the capacity comparing device 126. Subsequently, the data transmitted by the network I/F unit 18 is received by the network I/F unit 18 of the other complex machine, and the data storage controller 127 of the other complex machine stores the data received by the network I/F unit 18 in the HDD.

Accordingly, the data is transmitted to the complex machine including the HDD judged to have a largest free capacity out of a plurality of complex machines, and the transmitted data is received and registered in the database of the HDD. Therefore, the data registered in the database can be utilized, facilitating the data management.

Further, a document is read by the scanner unit (document reading means) 13 to obtain a document image data, and the data storage instructing device 125 instructs the storage of the document image data read by the scanner unit 13. Upon such an instruction, the capacity comparing device 126 confirms the free capacities of the HDDs of all the complex machines connected on the network to compare the free capacities of the HDDs. Then, the network I/F unit 18 transmits the document image data to the complex machine including the HDD judged to have a largest free capacity by the capacity comparing device 126. The network I/F unit 18 of the other complex machine receives the document image data transmitted from the former network I/F unit 18, and the data storage controller 127 of the other complex machine stores the document image data received by the network I/F unit 18 in the HDD. Therefore, document image data read by the scanner unit 13 can be stored while being decentralized among a plurality of complex machines.

Although all the read image data are stored in the HDDs in this embodiment, the present invention is not particularly limited thereto, and divided image data obtained by dividing a read image data into a plurality of sections may be stored in a plurality of complex machines. For example, in the case of too many documents or in the case of reading a color document, a data amount becomes too large and may not be stored in one HDD. For example, an image data of 100 documents may be divided into two data of 50 documents, and the divided image data may be separately stored in two HDDs. Specifically, the network I/F unit 18 divides an image data into a plurality of divided image data, and successively transmits each divided image data to the complex machine including the HDD judged to have a largest free capacity by the capacity comparing device 126. For example, if an image data is divided into two divided image data and the HDD 21 of the second complex machine 2 has a largest free capacity, the first divided image data is transmitted to the second complex machine 2 and stored in the HDD 21. After the first divided image data is stored in the HDD 21, the capacity comparing device 126 again confirms the free capacities of the HDDs of all the complex machines connected on the network to compare the free capacities of the respective HDDs. At this time, the remaining second divided image data is stored in the HDD 11 if the HDD 11 of the first complex machine 1 has a largest free capacity; transmitted to the second complex machine 2 to be stored in the HDD 21 if the HDD 21 of the second complex machine 2 has a largest free capacity; and transmitted to the third complex machine 3 to be stored in the HDD 31 if the HDD 31 of the third complex machine 3 has a largest free capacity. In other words, the processings from Steps S7 to S18 shown in FIG. 3 are repeatedly carried out until all the divided image data are stored.

As described above, the network I/F unit 18 divides the image data into a plurality of divided image data, and transmits the first divided image data to the complex machine including the HDD judged to have a largest free capacity by the capacity comparing device 126. The network I/F unit 18 of the other complex machine receives the first divided image data transmitted by the network I/F UNIT 18, and the data storage controller 127 of the other complex machine stores the first divided image data received by the network I/F unit 18 in the HDD. After the first divided image data is stored in the HDD, the capacity comparing device 126 again confirms the free capacities of the HDDs of all the complex machines connected on the network to compare the free capacities of the respective HDDs for the storage of the next divided image data. If the capacity of a data to be stored is large, this data is stored in the HDDs of a plurality of complex machines while being divided. Thus, the data amounts stored in a plurality of complex machines can be equalized.

The aforementioned specific embodiment is mainly embraced by inventions having the following constructions.

An inventive data management system is constructed such that a plurality of image forming apparatuses are connected via a network, wherein one of the plurality of image forming apparatuses comprises data storage means for storing a data, instructing means for instructing the storage of the data, capacity comparing means for confirming the free capacity of the data storage means of the one image forming apparatus and that of the data storage means of each other image forming apparatus connected on the network to compare the free capacities of the respective data storage means, and data transmitting means for transmitting the data to the other image forming apparatus comprising the data storage means judged to have a largest free capacity by the capacity comparing means; and each other image forming apparatus comprises the data storage means for storing a data, data receiving means for receiving the data transmitted by the data transmitting means, and data storage control means for storing the data received by the data receiving means in the data storage means.

According to this construction, the data storage is instructed by the instructing means of the one image forming apparatus out of the plurality of image forming apparatuses and, upon such an instruction, the capacity comparing means confirms the free capacity of the data storage means of the one image forming apparatus and that of the data storage means of each other image forming apparatus to compare the free capacities of the respective data storage means. Then, the data transmitting means transmits the data to the other image forming apparatus comprising the data storage means judged to have the largest free capacity by the capacity comparing means. The data receiving means of the other image forming apparatus receives the data transmitted by the data transmitting means and the data storage controlling means stores the data received by the data receiving means in the data storage means.

Accordingly, data are stored in a decentralized manner depending on the free capacities of the respective data storage means of the plurality of image forming apparatuses connected on the network. Hence, the data amounts stored in the respective image forming apparatuses connected on the network can be equalized. This can prevent the saturation of the capacities of the data storage means. Therefore, even if a print job of a large capacity is created, this print job can be processed.

In the above data management system, it is preferable that data compiled into a database are stored in each data storage means; the instructing means instructs the registration of a data in the database of the data storage means; and the capacity comparing means confirms the free capacity of the data storage means of the one image forming apparatus and that of the data storage means of each other image forming apparatus to compare the free capacities of the respective data storage means if the registration in the database is instructed by the instructing means.

According to this construction, the data compiled into the database are stored in each data storage means, and the registration of the data in the database of the data storage means is instructed by the instructing means. The capacity comparing means confirms the free capacity of the data storage means of the one image forming apparatus and that of the data storage means of each other image forming apparatus to compare the free capacities of the respective data storage means if the registration in the database is instructed by the instructing means. Then, the data transmitting means transmits the data to the other image forming apparatus including the data storage means judged to have a largest free capacity by the capacity comparing means, the data receiving means receives the data transmitted by the data transmitting means, and the data storage controlling means stores the data received by the data receiving means in the data storage means.

Accordingly, the data is transmitted to the image forming apparatus including the data storage means judged to have a largest free capacity out of the data storage means of the plurality of image forming apparatuses, and the transmitted data is received and registered in the database. Thus, the data registered in the database can be utilized, facilitating the data management.

Further, in the data management system, it is preferable that each other image forming apparatus further comprises instructing means for instructing the storage of data, and that the instructing means of the other image forming apparatus does not instruct the data storage if the data storage is instructed by the instructing means of the one image forming apparatus.

According to this construction, the instructing means of each other image forming apparatus does not instruct the data storage if the data storage is instructed by the instructing means of the one image forming apparatus. Thus, out of the plurality of image forming apparatuses, there is always only one image forming apparatus that can instruct the data storage to each other image forming apparatus, wherefore the simultaneous storage of the data in a plurality of image forming apparatuses can be prevented.

In the above data management system, it is preferable that the data transmitting means divides the data into a plurality of divided data and transmits the first divided data to the other image forming apparatus including the data storage means judged to have a largest free capacity by the capacity comparing means; the data receiving means receives the divided data transmitted by the data transmitting means; the data storage controlling means stores the divided data received by the data receiving means in the data storage means; and the capacity comparing means again confirms the free capacity of the data storage means of the one image forming apparatus and that of the data storage means of each other image forming apparatus connected on the network to compare the free capacities of the respective data storage means for the storage of the next divided data after the first divided data is stored in the data storage means.

According to this construction, the data transmitting means divides the data into a plurality of divided data and transmits the first divided data to the other image forming apparatus including the data storage means judged to have the largest free capacity by the capacity comparing means. Then, the data receiving means of the other image forming apparatus receives the first divided data transmitted by the data transmitting means, and the data storage controlling means stores the first divided data received by the data receiving means in the data storage means. After the first divided data is stored in the data storage means, the capacity comparing means again confirms the free capacity of the data storage means of the one image forming apparatus and that of the data storage means of each other image forming apparatus connected on the network to compare the free capacities of the respective data storage means for the storage of the next divided image.

Since the data is stored in a plurality of image forming apparatuses while being divided if the capacity of the data to be store is large, the data amounts stored in a plurality of image forming apparatuses can be equalized.

In the above data management system, it is preferable that the one image forming apparatus further comprises document reading means for obtaining a document image data by reading a document; the instructing means instructs the storage of the document image data read by the data reading means; the capacity comparing means confirms the free capacity of the data storage means of the one image forming apparatus and the free capacity of the data storage means of each other image forming apparatus connected on the network to compare the free capacities of the respective data storage means if the storage of the document image data is instructed by the instructing means; the data transmitting means transmits the document image data to the other image forming apparatus including the data storage means judged to have a largest free capacity by the capacity comparing means; the data receiving means receives the document image data transmitted by the data transmitting means; and the data storage controlling means stores the document image data received by the data receiving means in the data storage means of the other image forming apparatus.

According to this construction, the data reading means reads the document to obtain the document image data, and the instructing means instructs the storage of the document image data read by the data reading means. Upon such an instruction, the capacity comparing means confirms the free capacity of the data storage means of the one image forming apparatus and the free capacity of the data storage means of each other image forming apparatus connected on the network to compare the free capacities of the respective data storage means. Then, the data transmitting means transmits the document image data to the other image forming apparatus including the data storage means judged to have the largest free capacity by the capacity comparing means. The data receiving means of the other image forming apparatus receives the document image data transmitted by the data transmitting means, and the data storage controlling means stores the document image data received by the data receiving means in the data storage means of the other image forming apparatus. Accordingly, document image data read by the data reading means can be stored while being decentralized among a plurality of image forming apparatuses.

In the data management system, it is preferable that the one image forming apparatus further comprises image data receiving means for receiving an image data transmitted from an external apparatus; the instructing means instructs the storage of the image data received by the image data receiving means; the capacity comparing means confirms the free capacity of the data storage means of the one image forming apparatus and the free capacity of the data storage means of each other image forming apparatus connected on the network to compare the free capacities of the respective data storage means if the storage of the image data is instructed by the instructing means; the data transmitting means transmits the image data to the other image forming apparatus including the data storage means judged to have a largest free capacity by the capacity comparing means; the data receiving means receives the image data transmitted by the data transmitting means; and the data storage controlling means stores the image data received by the data receiving means in the data storage means of the other image forming apparatus.

According to this construction, the image data receiving means receives the image data transmitted from the external apparatus, and the instructing means instructs the storage of the image data received by the image data receiving means. Upon such an instruction, the capacity comparing means confirms the free capacity of the data storage means of the one image forming apparatus and that of the data storage means of each other image forming apparatus connected on the network to compare the free capacities of the respective data storage means. Then, the data transmitting means transmits the image data to the other image forming apparatus including the data storage means judged to have the largest free capacity by the capacity comparing means. The data receiving means of the other image forming apparatus receives the image data transmitted by the data transmitting means, and the data storage controlling means stores the image data received by the data receiving means in the data storage means of the other image forming apparatus. Accordingly, image data transmitted from external apparatuses can be stored while being decentralized among a plurality of image forming apparatuses.

In the data management system, it is preferable that the one image forming apparatus further comprises facsimile data receiving means for receiving a facsimile data transmitted via a telephone circuit; the instructing means instructs the storage of the facsimile data received by the facsimile data receiving means; the capacity comparing means confirms the free capacity of the data storage means of the one image forming apparatus and that of the data storage means of each other image forming apparatus connected on the network to compare the free capacities of the respective data storage means if the storage of the facsimile data is instructed by the instructing means; the data transmitting means transmits the facsimile data to the other image forming apparatus including the data storage means judged to have a largest free capacity by the capacity comparing means; the data receiving means receives the facsimile data transmitted by the data transmitting means; and the data storage controlling means stores the facsimile data received by the data receiving means in the data storage means of the other image forming apparatus.

According to this construction, the facsimile data receiving means receives the facsimile data transmitted via the telephone circuit, and the instructing means instructs the storage of the facsimile data received by the facsimile data receiving means. Upon such an instruction, the capacity comparing means confirms the free capacity of the data storage means of the one image forming apparatus and that of the data storage means of each other image forming apparatus connected on the network to compare the free capacities of the respective data storage means. Then, the data transmitting means transmits the facsimile data to the other image forming apparatus including the data storage means judged to have the largest free capacity by the capacity comparing means. The data receiving means of the other image forming apparatus receives the facsimile data transmitted by the data transmitting means, and the data storage controlling means stores the facsimile data received by the data receiving means in the data storage means of the other image forming apparatus. Accordingly, facsimile data received via the telephone circuit can be stored while being decentralized among a plurality of image forming apparatuses.

In the data management system, it is preferable that the one image forming apparatus further comprises registration receiving means for receiving an entry as to whether or not a data is to be registered in a database of the data storage means, and that the instructing means instructs the storage of the data if the registration of the data is received by the registration receiving means.

According to this construction, the entry as to whether or not the data is to be registered in the database of the data storage means is made by a user, and the storage of the data is instructed by the instructing means if the registration of the data is received by the registration receiving means. Accordingly, the storage capacity can be cut down since the user preferring not to store the data can skip the storage of the data.

In the data management system, it is preferable that the one image forming apparatus further comprises registration start information transmitting means for transmitting registration start information for notifying the start of the registration in the database to each other image forming apparatus if the data storage is instructed by the instructing means; each other image forming apparatus further comprises registration start information receiving means for receiving the registration start information transmitted by the registration start information transmitting means; and the instructing means of each other image forming apparatus does not instruct the data storage if the registration start information is received by the registration start information receiving means.

According to this construction, the registration start information transmitting means of the one image forming apparatus transmits the registration start information for notifying the start of the registration in the database to each other image forming apparatus. Then, the registration start information receiving means of each other image forming apparatus receives the registration start information transmitted by the registration start information transmitting means. In such a case, the instructing means of the other image forming apparatus does not instruct the data storage.

Accordingly, out of a plurality of image forming apparatuses, there is always only one image forming apparatus that can instruct the data storage to each other image forming apparatus, which can prevent the simultaneous storage of the data in a plurality of image forming apparatuses.

In the data management system, it is preferable that the one image forming apparatus further comprises confirm instruction transmitting means for transmitting confirm instruction for instructing the confirmation of the free capacity of the data storage means to each other image forming apparatus; each other image forming apparatus further comprises confirm instruction receiving means for receiving the confirm instruction transmitted by the confirm instruction transmitting means, confirming means for confirming the free capacity of the data storage means if the confirm instruction is received by the confirm instruction receiving means, and free capacity transmitting means for transmitting the free capacity of the data storage means confirmed by the confirming means to the one image forming apparatus; the one image forming apparatus further comprises free capacity receiving means for receiving the free capacity transmitted by the free capacity transmitting means; and the capacity comparing means compares the free capacity of the data storage means of the one image forming apparatus and that of the data storage means of each other image forming apparatus received by the free capacity receiving means.

According to this construction, the confirm instruction transmitting means of the one image forming apparatus transmits the confirm instruction for instructing the confirmation of the free capacity of the data storage means to each other image forming apparatus, and the confirm instruction receiving means of each other image forming apparatus receives the confirm instruction transmitted by the confirm instruction transmitting means. If the confirm instruction receiving means receives the confirm instruction, the confirming means confirms the free capacity of the data storage means and the free capacity transmitting means transmits the free capacity of the data storage means confirmed by the confirming means to the one image forming apparatus. Subsequently, the free capacity receiving means of the one image forming apparatus receives the free capacity transmitted by the free capacity transmitting means, and the capacity comparing means compares the free capacity of the data storage means of the one image forming apparatus and that of the data storage means of each other image forming apparatus received by the free capacity receiving means.

Accordingly, if the confirm instruction transmitted by the one image forming apparatus is received, the free capacity of the data storage means is confirmed in each other image forming apparatus and the confirmed free capacity is transmitted to the one image forming apparatus. Thus, the free capacity of each other image forming apparatus can be securely obtained.

In the data management system, it is also preferable that the one image forming apparatus further comprises registration permitting information transmitting means for transmitting registration permitting information for notifying the completion of the data storage in the data storage means to each other image forming apparatus; each other image forming apparatus further comprises registration permitting information receiving means for receiving the registration permitting information transmitted by the registration permitting information transmitting means; and the instructing means of each other image forming apparatus permits the data storage if the registration permitting information is received by the registration permitting information receiving means.

According to this construction, the registration permitting information transmitting means of the one image forming apparatus transmits the registration permitting information for notifying the completion of the data storage in the data storage means to each other image forming apparatus. Then, the registration permitting information receiving means of each other image forming apparatus receives the registration permitting information transmitted by the registration permitting information transmitting means. The instructing means of each other image forming apparatus permits the data storage upon the receipt of the registration permitting information by the registration permitting information receiving means.

Accordingly, the completion of the data storage in the one image forming apparatus can be notified to each other image forming apparatus, whereby the data storage in each other image forming apparatus can be started.

The inventive image forming apparatus is an image forming apparatus connected with a plurality of image forming apparatuses via a network and comprising data storage means for storing a data, instructing means for instructing the storage of the data, capacity comparing means for comparing the free capacity of the data storage means of the image forming apparatus with that of data storage means of each other image forming apparatus connected on the network to compare the free capacities of the respective data storage means if the data storage is instructed by the instructing means, data transmitting means for transmitting the data to the other image forming apparatus if the free capacity of the other image forming apparatus is judged to be larger than the free capacity of the image forming apparatus by the capacity comparing means, and data storage controlling means for storing the data in the data storage means if the free capacity of the image forming apparatus is judged to be larger than that of each other image forming apparatus by the capacity comparing means.

According to this construction, if the data storage is instructed by the instructing means, the capacity comparing means compares the free capacity of the data storage means of the image forming apparatus with that of the data storage means of each other image forming apparatus connected on the network to compare the free capacities of the respective data storage means. If the free capacity of the other image forming apparatus is judged to be larger than that of the image forming apparatus by the capacity comparing means, the data is transmitted to the other image forming apparatus by the data transmitting means. On the other hand, if the free capacity of the image forming apparatus is judged to be larger than that of each other image forming apparatus by the capacity comparing means, the data is stored in the data storage means by the data storage controlling means.

Since data can be stored in a decentralized manner depending on the free capacities of the respective data storage means of a plurality of image forming apparatuses connected on the network, the data amounts stored in a plurality of image forming apparatuses connected on the network can be equalized. This can prevent the saturation of the capacities of the data storage means. Therefore, even if a print job of a large capacity is created, this print job can be processed.

This application is based on patent application No. 2004-345966 filed in Japan, the contents of which are hereby incorporated by references.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds are therefore intended to embraced by the claims.

What is claimed is:

1. A data management system in which a plurality of image forming apparatuses are connected via a network, characterized in that:
one of a plurality of image forming apparatuses comprises:
data storage means for storing a data,
instructing means for instructing the storage of the data,
capacity comparing means for confirming the free capacity of the data storage means of the one image forming apparatus with that of data storage means of each other image forming apparatus connected on the network to compare the free capacities of the respective data storage means if the data storage is instructed by the instructing means, and
data transmitting means for transmitting the data to the other image forming apparatus comprising the data storage means judged to have a largest free capacity by the capacity comparing means; and
each other image forming apparatus comprises:
the data storage means for storing a data,
data receiving means for receiving the data transmitted by the data transmitting means, and
data storage controlling means for storing the data received by the data receiving means in the data storage means.

2. A data management system according to claim 1, wherein:
data compiled into a data base are stored in each data storage means,
the instructing means instructs the registration of a data in the database of the data storage means, and
the capacity comparing means confirms the free capacity of data storage means of the one image forming apparatus with that of the data storage means of each other image forming apparatus connected on the network to compare the free capacities of the respective data storage means if the registration in the database is instructed by the instructing means.

3. A data management system according to claim 2, wherein the one image forming apparatus further comprises registration receiving means for receiving an entry as to whether or not the data is to be registered in the database of the data storage means, and the instructing means instructs the storage of the data if the registration of the data is received by the registration receiving means.

4. A data management system according to claim 1, wherein:
each other image forming apparatus further comprises instructing means for instructing the data storage, and
the instructing means of each other image forming apparatus does not instruct the data storage if the data storage is instructed by the instructing means of the one image forming apparatus.

5. A date management system according to claim 4, wherein:
the one image forming apparatus further comprises registration start information transmitting means for transmitting registration start information for notifying the start of the registration in the database to each other image forming apparatus if the data storage is instructed by the instructing means,
each other image forming apparatus further comprises registration start information receiving means for receiving the registration start information transmitted by the registration start information transmitting means, and
the instructing means of each other image forming apparatus does not instruct the data storage if the registration start information is received by the registration start information receiving means.

6. A date management system according to claim 5, wherein:
the one image forming apparatus further comprises registration permitting information transmitting means for transmitting registration permitting information for notifying the completion of the data storage in the data storage means to each other image forming apparatus,
each other image forming apparatus further comprises registration permitting information receiving means for receiving the registration permitting information transmitted by the registration permitting information transmitting means, and
the instructing means of each other image forming apparatus permits the data storage if the registration permitting information is received by the registration permitting information receiving means.

7. A data management system according to claim 1, wherein:
the data transmitting means divides the data into a plurality of divided data and transmits the first divided data to the other image forming apparatus comprising the data storage means judged to have a largest free capacity by the capacity comparing means,
the data receiving means receives the first divided data transmitted by the data transmitting means,
the data storage controlling means stores the first divided data received by the data receiving means in the data storage means of the other image forming apparatus, and
the capacity comparing means again confirms the free capacity of the data storage means of the one image forming apparatus with that of the data storage means of each other image forming apparatus connected on the network to compare the free capacities of the respective data storage means for the storage of the next divided data.

8. A data management system according to claim 1, wherein:
the one image forming apparatus further comprises document reading means for obtaining a document image data by reading a document,
the instructing means instructs the storage of the document image data read by the document reading means,
the capacity comparing means confirms the free capacity of the data storage means of the one image forming apparatus with that of the data storage means of each other image forming apparatus connected on the network to compare the free capacities of the respective data storage means if the storage of the document image data is instructed by the instructing means,
the data transmitting means transmits the document image data to the other image forming apparatus comprising the data storage means judged to have a largest free capacity by the capacity comparing means,
the data receiving means receives the document image data transmitted by the data transmitting means, and
the data storage controlling means stores the document image data received by the data receiving means in the data storage means of the other image forming apparatus.

9. A data management system according to claim 1, wherein:
the one image forming apparatus further comprises image data receiving means for receiving an image data transmitted by an external apparatus,
the instructing means instructs the storage of the image data received by the image data receiving means,
the capacity comparing means confirms the free capacity of the data storage means of the one image forming apparatus with that of the data storage means of each other image forming apparatus connected on the network to compare the free capacities of the respective data storage means if the storage of the image data is instructed by the instructing means,
the data transmitting means transmits the image data to the other image forming apparatus comprising the data storage means judged to have a largest free capacity by the capacity comparing means,
the data receiving means receives the image data transmitted by the data transmitting means, and
the data storage controlling means stores the image data received by the data receiving means in the data storage means of the other image forming apparatus.

10. A data management system according to claim 1, wherein:
the one image forming apparatus further comprises facsimile data receiving means for receiving a facsimile data transmitted via a telephone circuit,
the instructing means instructs the storage of the facsimile data received by the facsimile data receiving means,
the capacity comparing means confirms the free capacity of the data storage means of the one image forming apparatus with that of the data storage means of each other image forming apparatus connected on the network to compare the free capacities of the respective data storage means if the storage of the facsimile data is instructed by the instructing means,
the data transmitting means transmits the facsimile data to the other image forming apparatus comprising the data storage means judged to have a largest free capacity by the capacity comparing means,
the data receiving means receives the facsimile data transmitted by the data transmitting means, and
the data storage controlling means stores the facsimile data received by the data receiving means in the data storage means of the other image forming apparatus.

11. A date management system according to claim 1, wherein:
the one image forming apparatus further comprises confirm instruction transmitting means for transmitting a confirm instruction to instruct the confirmation of the free capacity of the data storage means to each other image forming apparatus,
each other image forming apparatus further comprises confirm instruction receiving means for receiving the confirm instruction transmitted by the confirm instruction transmitting means, confirming means for confirming the free capacity of the data storage means if the confirm instruction is received by the confirm instruction receiving means, and free capacity transmitting means for transmitting the free capacity of the data storage means confirmed by the confirming means to the one image forming apparatus,
the one image forming apparatus further comprises free capacity receiving means for receiving the free capacity transmitted by the free capacity transmitting means, and
the capacity comparing means compares the free capacity of the data storage means of the one image forming apparatus and that of the data storage means of each other image forming apparatus received by the free capacity receiving means.

12. An image forming apparatus connected with a plurality of image forming apparatuses via a network, comprising:
data storage means for storing a data,
instructing means for instructing the storage of the data,
capacity comparing means for confirming the free capacity of the data storage means of the image forming apparatus with that of data storage means of each other image forming apparatus connected on the network to compare the free capacities of the respective data storage means if the data storage is instructed by the instructing means,
data transmitting means for transmitting the data to the other image forming apparatus if the free capacity of the other image forming apparatus is judged to be larger than that of the image forming apparatus by the capacity comparing means, and
data storage controlling means for storing the data in the data storage means if the free capacity of the image forming apparatus is judged to be larger than that of each other image forming apparatus by the capacity comparing means.
